(19) United States
(12) Patent Application Publication
(10) Pub. No.: US 2022/0148431 A1
(43) Pub. Date: May 12, 2022

(54) INFORMATION PROCESSING SYSTEM, INFORMATION PROCESSING METHOD, MANAGEMENT DEVICE, AND PROGRAM

(71) Applicant: NIPPON TELEGRAPH AND TELEPHONE CORPORATION, Tokyo (JP)

(72) Inventors: Hisatoshi KASAHARA, Tokyo (JP); Norihiro FUJIMOTO, Tokyo (JP); Hitoshi MIZUNO, Tokyo (JP); Seiya SATO, Tokyo (JP)

(73) Assignee: NIPPON TELEGRAPH AND TELEPHONE CORPORATION, Tokyo (JP)

(21) Appl. No.: 17/436,004

(22) PCT Filed: Feb. 25, 2020
(86) PCT No.: PCT/JP2020/007290

§ 371 Date: Sep. 2, 2021

(30) Foreign Application Priority Data
Mar. 5, 2019 (JP) 2019-039965

(51) Int. Cl. G08G 1/16; B60W 50/14; G01S 5/14; G01S 5/02; G01S 1/68

(52) U.S. Cl. CPC G08G 1/166; B60W 50/14; G01S 5/145; B60W 2050/146; G01S 1/685; B60W 2050/143; G01S 5/021

(57) ABSTRACT

A course of a mobile terminal device is estimated. An information processing system (S) includes: a plurality of transmission devices (1a, 1b) capable of transmitting predetermined radio waves; a terminal device (2) capable of receiving the predetermined radio waves; and a management device (3) communicably connected to the terminal device, wherein the terminal device (2) measures an intensity of the radio waves received from each of the plurality of transmission devices (1a, 1b) at intervals of a predetermined time period, and transmits measurement results to the management device (3), and the management device (3) estimates, from the measurement results, a distance from each of the plurality of transmission devices (1a, 1b) to the terminal device (2), and estimates a course of the terminal device (2) from the estimated distances.

### TECHNICAL FIELD

The present invention relates to an information processing system, an information processing method, a management device, and a program.

### BACKGROUND ART

When performing inspection, repair, and the like of an infrastructure embedded in a road pavement or under a road, it is necessary to set a construction working zone on the road before performing operations. At that time, in order to allow vehicles to appropriately pass, traffic control needs to be performed by disposing a traffic guiding person, and a sign or the like. On the other hand, in spite of such efforts, there are countless instances where a vehicle inadvertently collides with the construction working zone, thus causing an accident resulting in injury or death. The majority of such accidents result from the carelessness or dozing of drivers. In order to reduce such accidents resulting in injury or death, a system is known that detects a vehicle traveling along a construction lane at a high speed, and issues an alert to a traffic guiding person or an operator, using sound and light (e.g., NPL 1).

### CITATION LIST

### Non Patent Literature

[NPL 1] MIRAIT, “Development of Vehicle Entry Alert System “DOREMI (Registered Trademark)”,—Contributing to Reduction of Damage Caused by Accidents Resulting in Injury or Death Due to Vehicles Entering Construction Restricted Areas—”, [online], Oct. 19, 2016 [searched on Feb. 19, 2019], Internet (URL: https://www.mirait.co.jp/news/upload_files/20161019.pdf)

### SUMMARY OF THE INVENTION

### Technical Problem

The technique according to NPL 1 above can only be applied to a single leading vehicle, and is therefore cannot be applied to a following vehicle. Accordingly, there is a need for a system that determines, in advance, an approach of a vehicle that is likely to collide with a construction worker, and issues an alert to the worker.

An object of the present invention made in view of such circumstances is to provide an information processing system, an information processing method, a management device, and a program that can estimate a course of a mobile terminal device.

### Means for Solving the Problem

In order to solve the above-described problems, an information processing system according to the present invention is an information processing system including: a plurality of transmission devices capable of transmitting predetermined radio waves; a terminal device capable of receiving the predetermined radio waves; and a management device communicably connected to the terminal device,

wherein the terminal device measures an intensity of the radio waves received from each of the plurality of transmission devices at intervals of a predetermined time period, and transmits measurement results to the management device, and

the management device estimates, from the measurement results, a distance from each of the plurality of transmission devices to the terminal device, and estimates a course of the terminal device from the estimated distances.

In order to solve the above-described problems, an information processing method according to the present invention is an information processing method performed in an information processing system: including a plurality of transmission devices capable of transmitting predetermined radio waves; a terminal device capable of receiving the predetermined radio waves; and a management device communicably connected to the terminal device, the method including the steps of:

measuring, by the terminal device, an intensity of the radio waves received from each of the plurality of transmission devices at intervals of a predetermined time period, and transmitting, by the terminal device, measurement results to the management device; and

estimating, by the management device, a distance from each of the plurality of transmission devices to the terminal device from the measurement results, and estimating, by the management device, a course of the terminal device from the estimated distances.

In order to solve the above-described problems, a management device according to the present invention is a management device to be communicably connected to a terminal device,

wherein the management device receives, from the terminal device, measurement results of a radio wave intensity obtained at intervals of a predetermined time period, and

estimates a distance from each of a plurality of transmission devices to the terminal device from the measurement results, and estimates a course of the terminal device from the estimated distances.

In order to solve the above-described problems, a program according to the present invention causes a computer of function as the above-described management device.

### Effects of the Invention

With the information processing system, the information processing method, the management device, and the program according to the present invention, it is possible to estimate a course of a mobile terminal device.

### BRIEF DESCRIPTION OF DRAWINGS

FIG. 1 is a schematic diagram of the present embodiment.

FIG. 2A is a diagram showing a first usage example of a transmission device.

FIG. 2B is a diagram showing a second usage example of the transmission device.

FIG. 3A is a schematic diagram of an information processing system.

FIG. 3B is a functional block diagram of a terminal device.

FIG. 3C is a functional block diagram of a management device.

FIG. 4 is a diagram showing a form of installation of the transmission device.

FIG. 5A is a diagram showing a positional relationship between a moving object and the transmission device at each time period.

FIG. 5B is a graph showing a relationship between the time and the radio wave intensity.

FIG. 5C is a graph showing a relationship between the time and the distance.

FIG. 6 is a diagram showing a database stored in the management device.

FIG. 7A is a diagram showing a first graph in the case where the possibility of collision is low.

FIG. 7B is a diagram showing a second graph in the case where the possibility of collision is low.

FIG. 7C is a diagram showing the movement of the moving object in the case where the possibility of collision is low.

FIG. 7D is a diagram showing a first graph in the case where the possibility of collision is high.

FIG. 7E diagram showing a second graph in the case where the possibility of collision is high.

FIG. 7F is a diagram showing the movement of the moving object in the case where the possibility of collision is high.

FIG. 8 is a schematic diagram when a confirmatory test is performed.

FIG. 9A is a diagram showing the movement of the moving object in the case where the possibility of collision is low.

FIG. 9B is a diagram showing a graph obtained when the possibility of collision is low.

FIG. 10A is a diagram showing the movement of the moving object in the case where the possibility of collision is high.

FIG. 10B is a diagram showing a graph obtained in the case where the possibility of collision is high.

FIG. 11 is a diagram showing a flowchart of processing performed by the management device.

### DESCRIPTION OF EMBODIMENTS

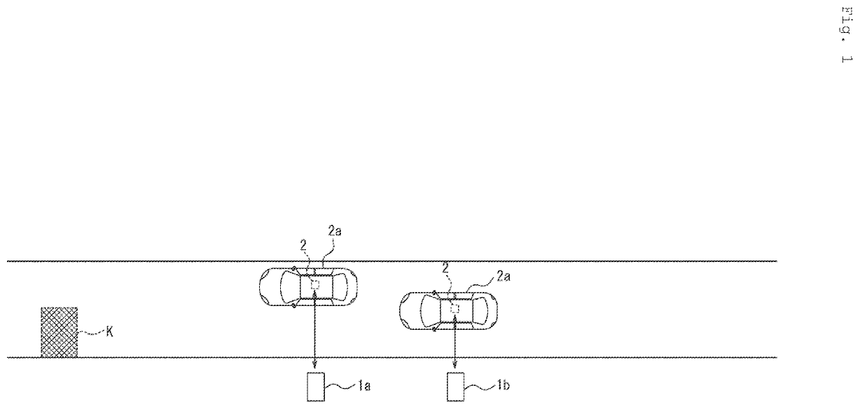

First, an outline of the processing performed in the present embodiment will be described. As shown in FIG. 1, a terminal device 2 according to the present embodiment is, for example, a smartphone carried by the driver of a moving object 2a such as a vehicle. The terminal device 2 may be installed in the moving object 2a. The terminal device 2 is mobile. The terminal device 2 has the receiving function of Bluetooth (registered trademark). Transmission devices 1 (a first transmission device 1a and a second transmission device 1b) according to the present embodiment are beacons that are installed on a roadside in the vicinity of a construction working zone K, and that are capable of transmitting Bluetooth (registered trademark) radio waves. As the beacons, for example, the beacon described in the document listed below can be applied.

WHERE, “EXBeacon Platform”, [online], [searched on Feb. 19, 2019], Internet (URL: https://where123.jp/platform)

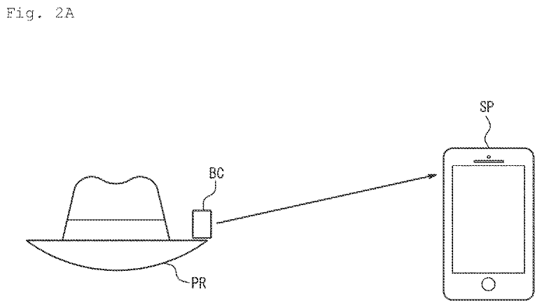

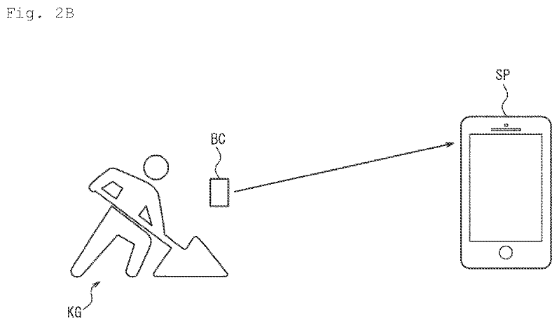

FIGS. 2A and 2 are diagrams illustrating a usage example of a beacon BC. As shown in FIG. 2A, the beacon BC may be installed in the vicinity of a product PR in a store. In this case, the beacon BC can transmit the detailed information or the like of the product to a smartphone SP of a customer who has approached the beacon BC within a predetermined distance. The smartphone SP can display the detailed information or the like of the product via an application. On the other hand, as shown in FIG. 2B, the beacon BC may be applied to a construction site KG. Specifically, the beacon BC is installed in the construction site KG, and transmits a notification to a smartphone SP of the driver of a moving object that has approached the construction site KG. The smartphone SP that has received the notification outputs voice such as “Construction site. Caution Please.”, for example, via an application.

Turning back to the description of FIG. 1, the terminal device 2 receives Bluetooth (registered trademark) radio waves from each of the first transmission device 1a and the second transmission device 1b at intervals of a predetermined time period, and measures the intensity of the radio waves. The terminal device 2 transmits the measured value to a management device 3 (not shown). From the relationship between the radio wave intensity and the distance, the management device 3 estimates the distance from each of the transmission devices 1a and 1b to the terminal device 2. The management device 3 estimates a course of the moving object 2a from the distance between each of the transmission devices 1a and 1b to the terminal device 2, and the change in the radio wave intensity received from each of the transmission devices 1a and 1b. From the estimated course, an information processing system S can determine the possibility of collision of the moving object 2a with the construction working zone K. The construction working zone K is an obstacle on a traveling path of the moving object 2a. Furthermore, the management device 3 may notify, via the terminal device 2 using voice or screen display, or the like, the driver in the vehicle that the construction working zone K is approaching. Thus, the management device 3 can prompt the driver to pay attention. The present invention is applicable not only to determine the possibility of collision of a vehicle, but is applicable also when the speed and the position of various other moving objects are to be known.

In the following, an information processing method performed in the present embodiment will be described in detail.

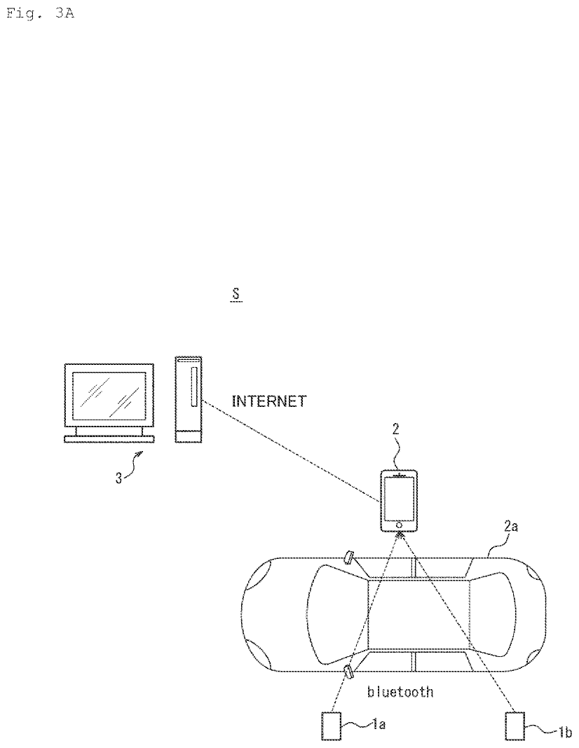

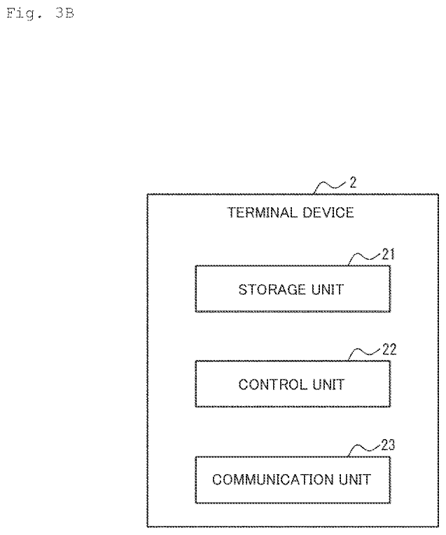

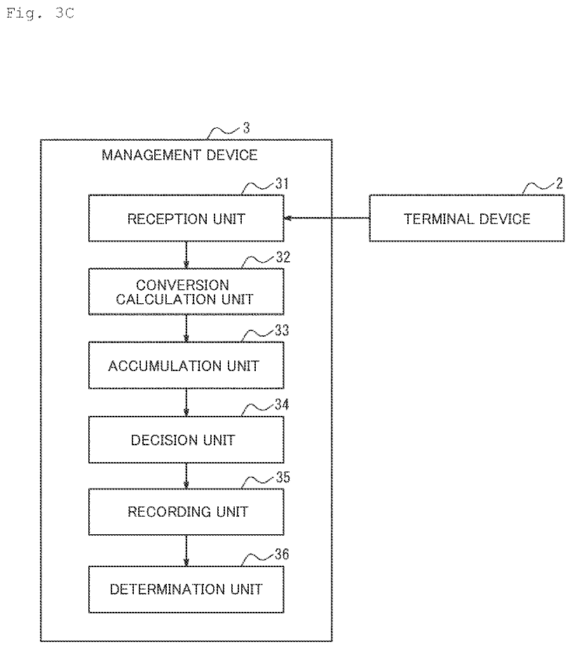

FIG. 3A is a diagram showing main components of the information processing system S according to the present embodiment. The information processing system S includes a first transmission device 1a, a second transmission device 1b, a terminal device 2, and a management device 3. The terminal device 2 is carried by the driver of a moving object 2a. The terminal device 2 can receive, for example, radio waves such as Bluetooth (registered trademark) from the first transmission device 1a and the second transmission device 1b. The terminal device 2 and the management device 3 are communicably connected to each other, for example, via any network such as the Internet.

In order to simplify the description, two transmission devices 1a and 1b are depicted in FIG. 3A. However, the information processing system S may include three or more transmission devices 1. In FIG. 3A, one terminal device 2 is depicted. However, the number of terminal devices 2 included in the information processing system S may be two or more. In FIG. 3A, one management device 3 is depicted. However, the information processing system S may include two or more management devices 3.

The functional block diagrams of the terminal device 2 and the management device 3 will be described in detail below. Although the functions of the terminal device 2 and the management device 3 will be described in detail, this is not intended to exclude other functions.

As shown in FIG. 3B, the terminal device 2 includes a storage unit 21, a control unit 22, and a communication unit 23. The terminal device 2 is a Bluetooth (registered trademark) receiving terminal (e.g., a smartphone) carried by the driver of the moving object 2a. An application is installed in the terminal device 2. Using this application, the terminal device 2 measures the intensity of the received Bluetooth (registered trademark) radio waves, and transmits a measurement result to the management device 3. As an alternative, the terminal device 2 may be carried by a pedestrian or a vehicle such as a motorcycle, instead of being carried by the driver of an automobile.

The storage unit 21 includes one or more memories. “Memory” is, for example, a semiconductor memory, a magnetic memory, or an optical memory; however, the present invention is not limited thereto. Each of the memories included in the storage unit 21 may function as a main storage device, an auxiliary storage device, or a cache memory. The storage unit 21 may store information regarding a result obtained through analysis or processing performed by the control unit 22. The storage unit 21 may store a various types of information or the like that relate to the operation or control of the terminal device 2.

The control unit 22 includes one or more processors. “Processor” may be a general-purpose processor, or a dedicated processor specialized in specific processing. For example, the control unit 22 controls the overall operation of the terminal device 2. The control unit 22 performs control of other functional units included in the terminal device 2.

The communication unit 23 is an interface, and includes a communication module that performs communication with at least one of the first transmission device 1a, the second transmission device 1b, and the management device 3. The communication unit 23 can receive radio waves from the first transmission device 1a or the second transmission device 1b, and can transmit measurement results of the radio wave intensity to the management device 3.

As shown in FIG. 3C, the management device 3 includes a reception unit 31, a conversion calculation unit 32, an accumulation unit 33, a decision unit 34, a recording unit 35, and a determination unit 36. The processing performed by each of the conversion calculation unit 32, the decision unit 34, and the determination unit 36 is performed by one or multiple processors. The accumulation unit 33 and the recording unit 35 each may be one or more memories. The management device 3 can collect the intensity data of Bluetooth (registered trademark) radio waves, for example, and can derive the position and the speed of the terminal device 2 from the intensity data.

The reception unit 31 is an interface for receiving measurement results of the radio wave intensity from the terminal device 2.

The conversion calculation unit 32 converts the radio wave intensity measured by the terminal device 2 into a distance.

The accumulation unit 33 stores the distance calculated by the conversion calculation unit 32, and time information that is associated with the radio wave intensity.

The decision unit 34 decides a minimum value of the calculated distance for each transmission device 1.

The recording unit 35 records the minimum values decided by the decision unit 34.

The determination unit 36 estimates a course of the moving object 2a from the minimum values recorded by the recording unit 35. The estimation method will be described in detail in the following.

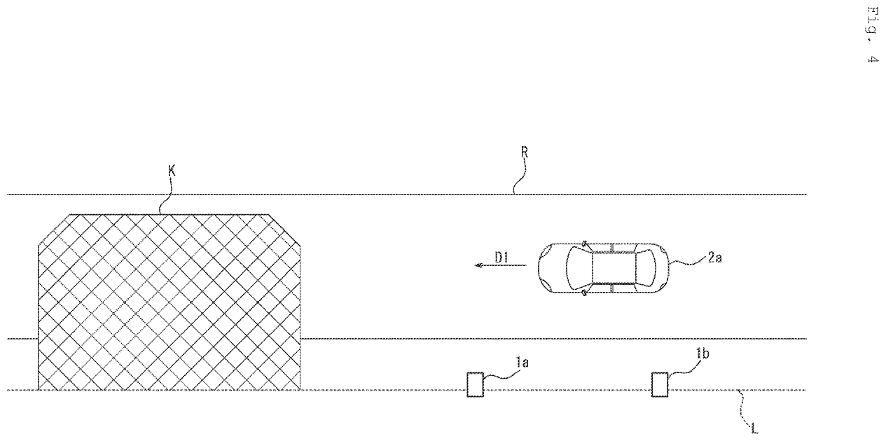

As shown in FIG. 4, the first transmission device 1a and the second transmission device 1b are installed on a roadside at positions nearer to the moving object 2a than the construction working zone K when the moving object 2a is viewed from a direction D1. The first transmission device 1a and the second transmission device 1b are installed such that a straight line L passing through the first transmission device 1a and the second transmission device 1b is substantially parallel to a roadway R.

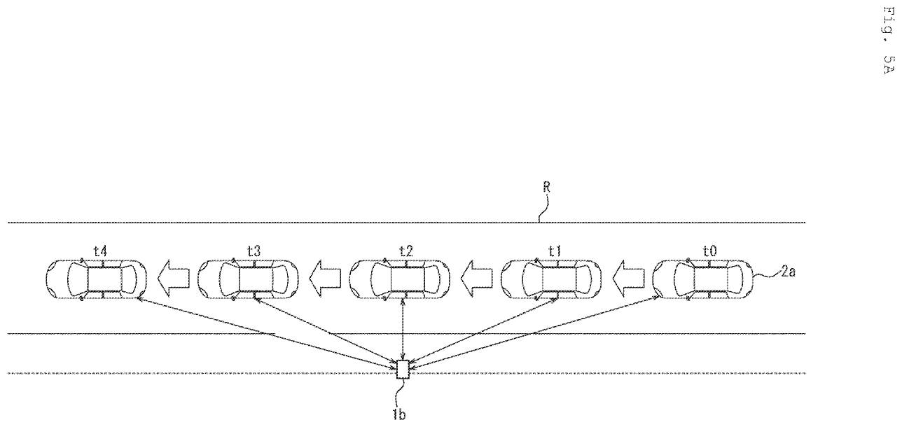

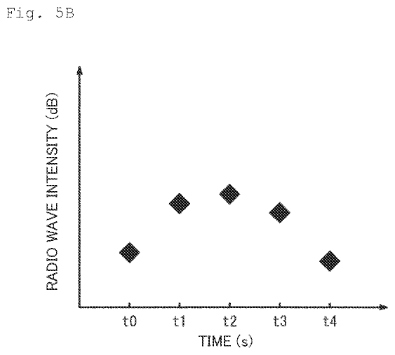

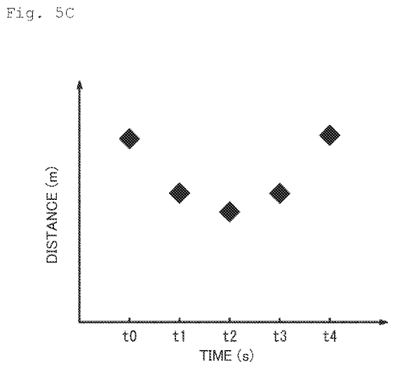

As shown in FIG. 5A, the moving object 2a travels along the roadway R from the right to the left. The moving object 2a first approaches the second transmission device 1b. When the terminal device 2 carried by the driver of the moving object 2a receives a radio wave intensity greater than or equal to a certain value, the management device 3 (not shown in FIG. 5A) detects that the moving object 2a is approaching the second transmission device 1b. At this time, a flow according to the present embodiment starts as follows.

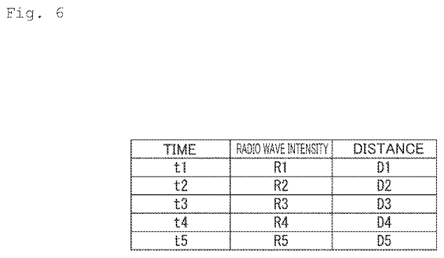

The management device 3 stores the radio wave intensity from the second transmission device 1b at each time period, which is received from the terminal device 2, as shown in FIG. 5B. The radio wave intensity has a correlation with the distance between the terminal device 2 and the second transmission device 1b. The management device 3 converts the radio wave intensity into a distance, using a predetermined relational expression, and records the distance as the distance at each time period as shown in FIG. 5C. In FIGS. 5B and 5C, graphs are used for the sake of convenience of description. However, as shown in FIG. 6, the management device 3 may record the radio wave intensity and the distance in association with the time without using a graph. Although five points are plotted in each of FIGS. 5B and 5C, the management device 3 may measure the radio wave intensity in a shorter span (or a longer span), and plot a larger number of points (or a smaller number of points).

The management device 3 performs the same processing for the first transmission device 1a as that performed for the second transmission device 1b. The description thereof has been omitted here for the sake of simplicity. The management device 3 records the distance for each transmission device 1.

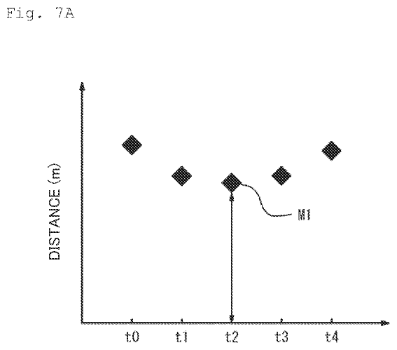

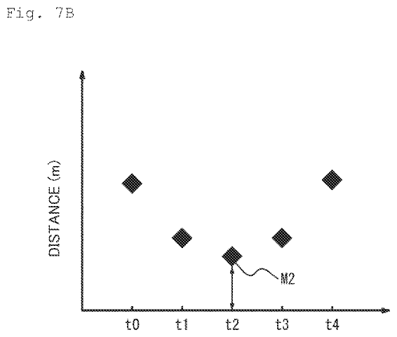

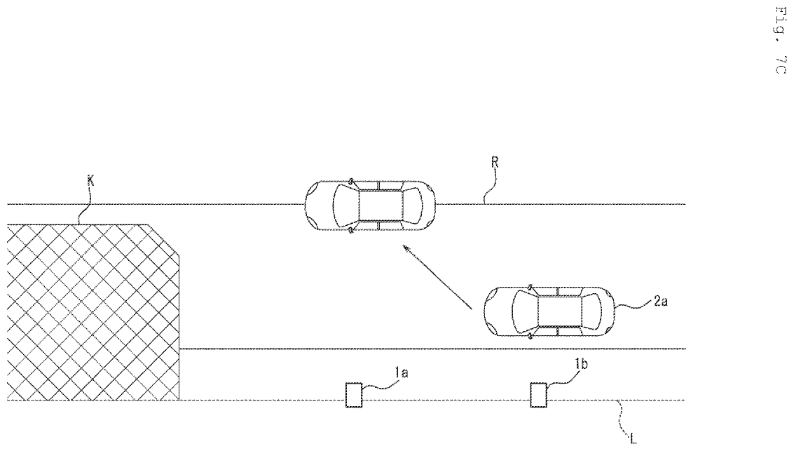

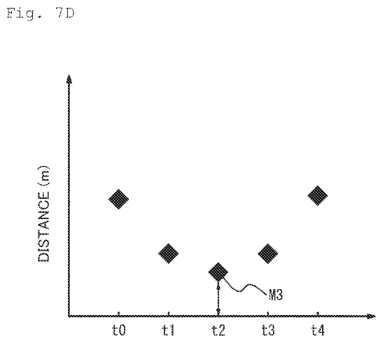

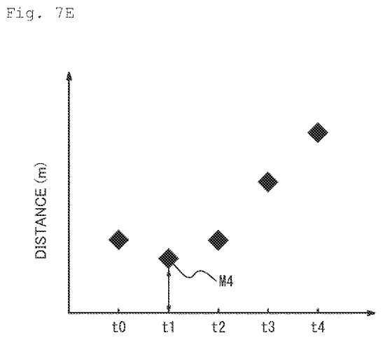

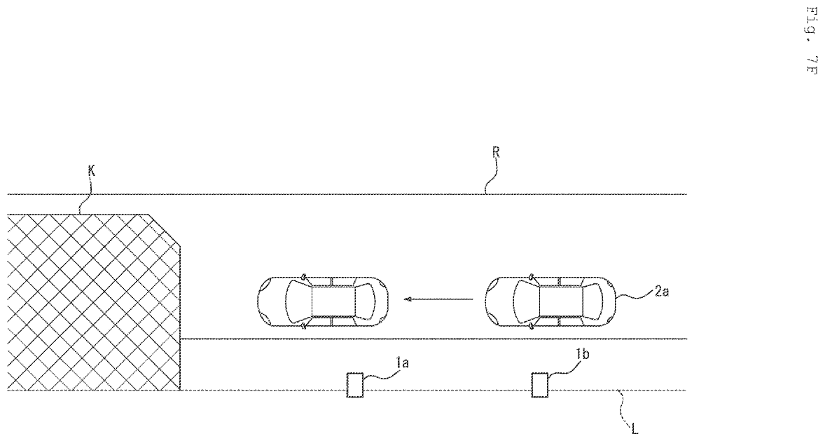

From the recorded distance information, the management device 3 determines the possibility of collision of the moving object 2a with the construction working zone K. The determination method is shown in FIGS. 7A to 7F.

As shown in FIGS. 7A and 7B, a minimum value (hereinafter referred to as a “first minimum value”) M1 of the distance measured for the first transmission device 1a is larger than a minimum value (hereinafter referred to as a “second minimum value”) M2 of the distance measured for the second transmission device 1b. Therefore, the management device 3 determines that the moving object 2a is moving away from the straight line L as shown in FIG. 7C, and the possibility of collision is low. As an alternative, the management device 3 may store the positional relationship between the first transmission device 1a and the construction working zone K, and the width of the construction working zone K. In this case, from the positional relationship and the width, the management device 3 may determine an increase range (i.e., an increase range from the second minimum value to the first minimum value) necessary to avoid the construction working zone K. The management device 3 may compare the determined necessary increase range and the actual increase range, and, when the latter is larger than the former, may determine that the possibility of collision is low. Thus, the management device 3 can estimate a course of the terminal device 2 from a change between the minimum value of the distance from the terminal device 2 to the first transmission device 1a, and the minimum value of the distance from the second transmission device 1b to the terminal device 2.

On the other hand, as shown in FIGS. 7D and 7E, when a first minimum value M3 is smaller than a second minimum value M4, the management device 3 determines that the possibility of collision is high because the moving object 2a is moving closer to the straight line L.

When the first minimum value is equal to the second minimum value, the management device 3 determines that the possibility of collision is high because the moving object 2a is within a certain distance from the straight line L as shown in FIG. 7F. As an alternative, when the first minimum value and the second minimum value are less than a predetermined value that is determined to be necessary to avoid the construction working zone K, the management device 3 may determine that the possibility of collision is high. On the other hand, when the first minimum value and the second minimum value are greater than or equal to the predetermined value, the management device 3 may determine that the possibility of collision is low.

In FIGS. 7A to 7F, the management device 3 determines the possibility of collision based on graphs. As an alternative, the management device 3 may compare the minimum values of the measured distances to each other without using graphs, and, when the minimum value measured for the first transmission device 1a is the same as, or smaller than the minimum value measured for the second transmission device 1b, the management device 3 may determine that the possibility of collision is high.

In the present embodiment, the transmission devices 1 are installed on only one side (i.e., the left side in the traveling direction of the moving object 2a) of a roadway. However, in another embodiment, the transmission devices 1 may be installed on both sides (i.e., opposing lanes) of a roadway. In this case, the management device 3 can acquire distance data pieces having phases opposite to each other from the transmissions devices 1 located on both sides, and thus can more accurately estimate a course of the moving object 2a, and determine the possibility of collision.

As described above, the management device 3 can determine whether the possibility of collision of the moving object 2a is high or low using the transmission devices 1. In another embodiment, the management device 3 identifies a moving object 2a having a high possibility of collision, and transmits warning information indicating that the possibility of collision is high to an alarm device (a speaker, a monitor, etc.) installed in the vicinity of the construction working zone K, a mobile phone terminal carried by an operator in the construction working zone K, or the terminal device 2. The terminal that has received the warning information can output the warning information using voice or screen display, or the like, thus reducing accidents resulting in injury or death.

[Confirmatory Test]

A test (simulation) was performed for the information processing system S described above. The relational expression between the radio wave intensity and the distance used in the test is as follows.

$$d = {10}^{\frac{( T - R )}{10 n}} \qquad [ Math . 1 ]$$

In this expression, the distance is set as d, the radio wave intensity transmitted from the transmission device 1 is set as T [dB], and the radio wave intensity received by the terminal device 2 is set as R [dB]. This expression is obtained by applying parameters suitable for the present simulation environment to the Friis transmission equation indicating that the intensity of a reception signal is inversely proportional to the square of distance in a free space. “n” in this expression is a coefficient that may vary depending on the type of the terminal device 2 or the presence or absence of an obstacle. For the present test environment, n=2.79, and T=−57.

In the following description, the management device 3 converts a radio wave intensity into a distance using the above-described relational expression. As an alternative, if any other relational expression is (e.g., empirically) present between the radio wave intensity and the distance, the management device 3 may use that relational expression.

In this test, the terminal device 2 and the management device 3 shown in FIG. 3A described above were used. Three transmission devices 1 were used, and these will be referred to as transmission devices A, B, and C, respectively.

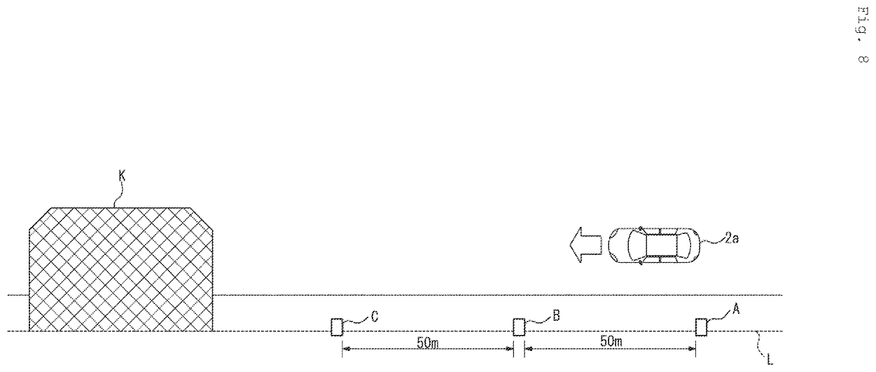

FIG. 8 shows the situation in which the transmission devices 1 are installed. The transmission devices A, B, and C are installed in this order from a location closer to the construction working zone K. The speed of the moving object 2a is 60 km/h. The distance between the transmission devices is 50 m. Each of the transmission devices records a radio wave intensity at intervals of one second.

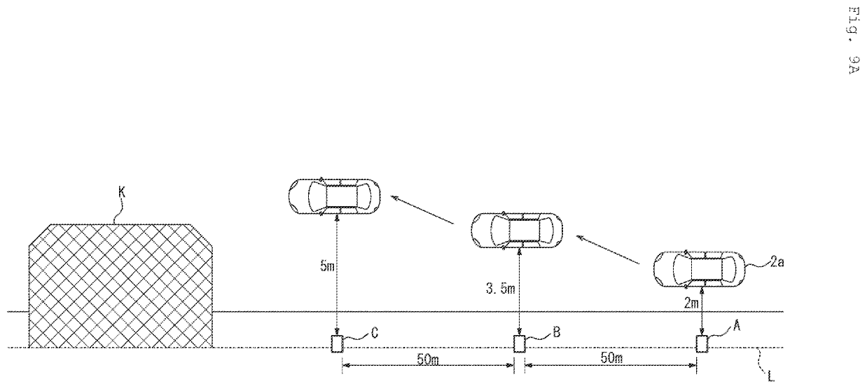

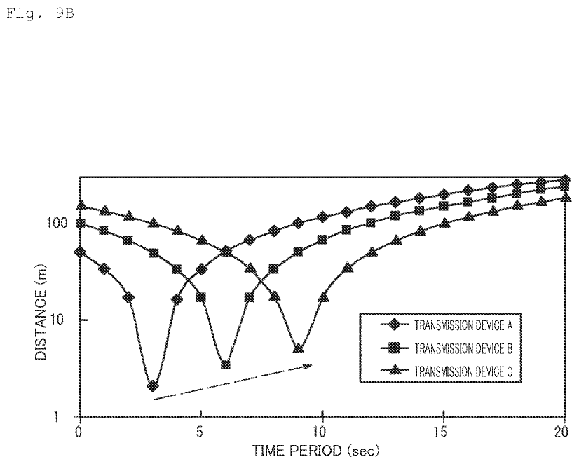

FIG. 9A shows an actual movement of the moving object 2a when the possibility of collision is low. FIG. 9B shows the graph obtained by the management device 3 in this case. As indicated by this graph, the minimum value of the distance increases over time. Therefore, the management device 3 determines that the moving object 2a is moving away from the straight line L in order to avoid the working zone.

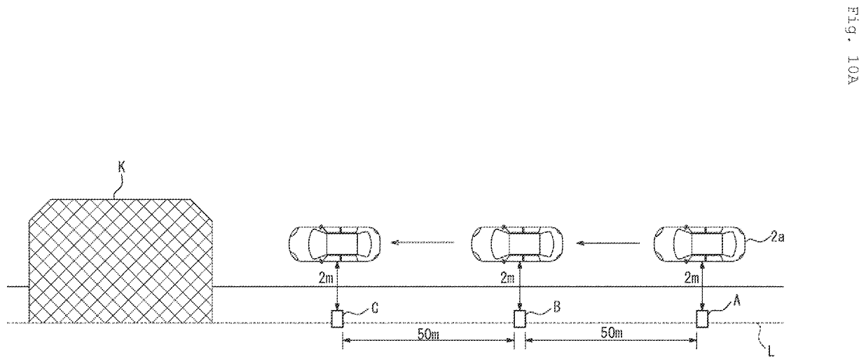

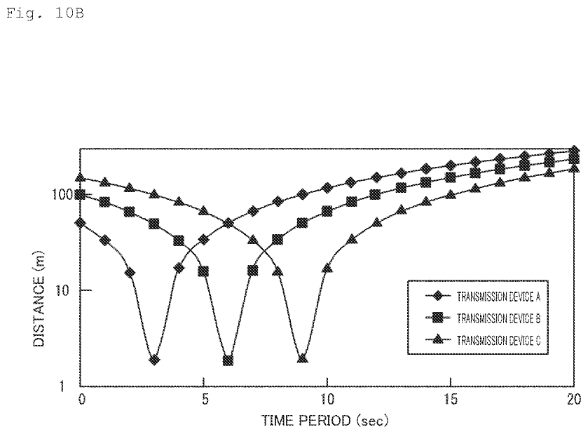

On the other hand, FIG. 10A shows an actual movement of the moving object 2a when the possibility of collision is high. FIG. 10B shows the graph obtained by the management device 3 in this case. As indicated by this graph, the minimum value of the distance is substantially constant irrespective of the passage of time. Therefore, the management device 3 determines that the course of the moving object 2a is parallel to the lane, and the moving object 2a shows no sign of avoiding the working zone (i.e., the possibility of collision is high).

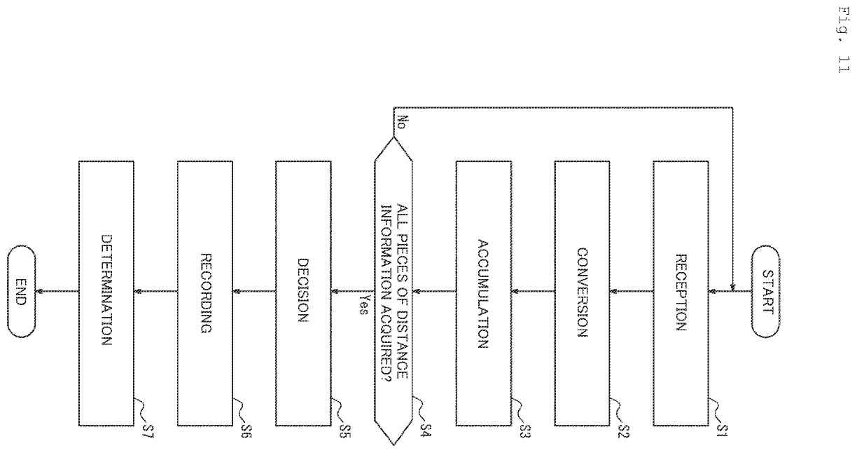

FIG. 11 shows a flowchart of the processing performed by the management device 3.

In step S1, the reception unit 31 receives a radio wave intensity and time information from each of the transmission devices 1 (e.g., the transmission device A, the transmission device B, and the transmission device C in the above-described confirmatory test).

In step S2, the conversion calculation unit 32 converts the radio wave intensity received from each of the transmission devices 1 into a distance.

In step S3, the accumulation unit 33 accumulates the distance and the time information corresponding to the distance.

In step S4, the decision unit 34 determines whether or not pieces of the distance information at all of predetermined times (e.g., times t0, t1, t2, t3, and t4 in the above-described confirmatory test) have been acquired from each of the transmission devices 1.

When the determination result is No in step S4, the management device 3 performs step S1 again.

On the other hand, when the determination result is Yes in step S4, the decision unit 34 decides, in step S5, a minimum value of the distance for each of the transmission devices 1.

In step S6, the recording unit 35 records the minimum values decided in step S5.

In step S7, the determination unit 36 estimates a course of the moving object 2a from the recorded minimum values, and determines the possibility of collision. The determination method is as described above, and therefore the description thereof has been omitted here.

As described above, according to the present embodiment, the terminal device 2 measures the intensity of the radio waves received from each of the first transmission device 1a and the second transmission device 1b at intervals of a predetermined time period, and transmits measurement results to the management device 3. The management device 3 estimates, from the measurement results, a distance from each of the first transmission device 1a and the second transmission device 1b to the terminal device 2, and estimates a course of the terminal device 2 from the estimated distances. With this configuration, the management device 3 can determine the possibility of collision of the terminal device 2 with an obstacle, thus reducing accidents. Furthermore, by performing such determination for a following terminal device 2, the management device 3 can further reduce accidents.

According to the present embodiment, the management device 3 estimates a course of the terminal device 2 from a change between a minimum value of the distance from the first transmission device 1a to the terminal device 2, and a minimum value of the distance from the second transmission device 1b to the terminal device 2. With this configuration, the management device 3 can even more accurately estimate the course.

According to the present embodiment, the management device 3 determines the possibility of collision of the moving object 2a with an obstacle on the traveling path, based on whether or not the change is greater than or equal to a predetermined value. With this configuration, the management device 3 can even more accurately determine the possibility of collision, while reducing false determinations.

According to the present embodiment, when the management device 3 determines that the possibility of collision is high, the management device 3 transmits, to the terminal device 2, warning information indicating that the possibility of collision is high, and the terminal device 2 outputs the warning information. With this configuration, the management device 3 can reduce accidents.

The management device 3 according to the present embodiment can be implemented by any computer and any program. Specifically, a program describing the details of the processing for implementing the functions of the management device 3 is recorded in a recording medium such as a memory, and the program is read and executed by a processor. Such a program can be provided via a network.

Alternatively, the program may be recorded in a computer-readable medium. By using a computer-readable medium, it is possible to install the program in a computer. Here, the computer-readable medium in which the program is recorded may be a non-transient recording medium. The non-transient recording medium may be, but is not particularly limited to, a recording medium such as a CD-ROM or a DVD-ROM, for example.

Although the present invention has been described based on drawings and examples, it should be noted that various modifications and alterations can be readily made by those skilled in the art based on the present disclosure. Therefore, it should be appreciated that such modifications and alterations fall within the scope of the present invention. For example, the functions and the like included in the constituent elements or the steps and the like can be rearranged so as not to be logically inconsistent, and a plurality of constituent elements or steps and the like can be combined into one, or may be divided.

### REFERENCE SIGNS LIST

S Information processing system
1 (1a, 1b) Transmission device
2 Terminal device
21 Storage unit
22 Control unit
23 Communication unit
2a Moving object
3 Management device
31 Reception unit
32 Conversion calculation unit
33 Accumulation unit
34 Decision unit
35 Recording unit
36 Determination unit

1. An information processing system comprising:
a plurality of transmission devices capable of transmitting predetermined radio waves; a terminal device capable of receiving the predetermined radio waves; and
a management device communicably connected to the terminal device, wherein the terminal device measures an intensity of the radio waves received from each of the plurality of transmission devices at intervals of a predetermined time period, and transmits measurement results to the management device, and the management device estimates, from the measurement results, a distance from each of the plurality of transmission devices to the terminal device, and estimates a course of the terminal device from the estimated distances.

2. The information processing system according to claim 1, wherein the plurality of transmission devices include a first transmission device and a second transmission device, and the management device estimates a course of the terminal device from a change between a minimum value of the distance from the first transmission device to the terminal device, and a minimum value of the distance from the second transmission device to the terminal device.

3. The information processing system according to claim 2, wherein the terminal device is installed in a moving object, and the management device determines, from the estimated course, a possibility of collision of the moving object with an obstacle on a traveling path.

4. The information processing system according to claim 3, wherein the management device determines a possibility of collision of the moving object with an obstacle on a traveling path, based on whether or not the change is greater than or equal to a predetermined value.

5. The information processing system according to claim 3, wherein, when the management device determines that the possibility of collision is high, the management device transmits, to the terminal device, warning information indicating that the possibility of collision is high, and the terminal device outputs the warning information.

6. A method performed in an information processing system including a plurality of transmission devices capable of transmitting predetermined radio waves, a terminal device capable of receiving the predetermined radio waves, and a management device communicably connected to the terminal device, the method comprising:
measuring, by the terminal device, an intensity of the radio waves received from each of the plurality of transmission devices at intervals of a predetermined time period; and
transmitting, by the terminal device, measurement results to the management device; and
estimating, by the management device, a distance from each of the plurality of transmission devices to the terminal device from the measurement results, and estimating, by the management device, a course of the terminal device from the estimated distances.

7. A management device to be communicably connected to a terminal device, wherein the management device receives, from the terminal device, measurement results of a radio wave intensity obtained at intervals of a predetermined time period, and estimates a distance from each of a plurality of transmission devices to the terminal device from the measurement results, and estimates a course of the terminal device from the estimated distances.

8. (canceled)

9. The information processing system according to claim 4, wherein, when the management device determines that the possibility of collision is high, the management device transmits, to the terminal device, warning information indicating that the possibility of collision is high, and the terminal device outputs the warning information.

10. The method according to claim 6, wherein the plurality of transmission devices include a first transmission device and a second transmission device, and the management device estimates a course of the terminal device from a change between a minimum value of the distance from the first transmission device to the terminal device, and a minimum value of the distance from the second transmission device to the terminal device.

11. The method according to claim 10, wherein the terminal device is installed in a moving object, and the management device determines, from the estimated course, a possibility of collision of the moving object with an obstacle on a traveling path.

12. The method according to claim 11, wherein the management device determines a possibility of collision of the moving object with an obstacle on a traveling path, based on whether or not the change is greater than or equal to a predetermined value.

13. The method according to claim 11, wherein, when the management device determines that the possibility of collision is high, the management device transmits, to the terminal device, warning information indicating that the possibility of collision is high, and the terminal device outputs the warning information.

14. The method according to claim 12, wherein, when the management device determines that the possibility of collision is high, the management device transmits, to the terminal device, warning information indicating that the possibility of collision is high, and the terminal device outputs the warning information.
